(19) United States
(12) Patent Application Publication
(10) Pub. No.: US 2009/0286567 A1
(43) Pub. Date: Nov. 19, 2009

(54) CELLULAR TELEPHONE SYSTEM

(76) Inventors: Alan Amron, Brooklyn, NY (US); Eric T. Brewer, Saratoga, CA (US)

Correspondence Address: OSTROLENK FABER GERB & SOFFEN, 1180 AVENUE OF THE AMERICAS, NEW YORK, NY, 100368403, US

(21) Appl. No.: 12/210,785

(22) Filed: Sep. 15, 2008

Related U.S. Application Data
(60) Provisional application No. 61/053,983, filed on May 16, 2008.

(51) Int. Cl. H04M 1/00

(52) U.S. Cl. 455/550.1

(57) ABSTRACT

A cellular telephone in accordance with an embodiment of the present application is operable to transmit voice data and additional digital data together to another similarly functional cellular telephone without the need for an external server. The cellular telephone operates like a server to coordinate transmission of all data between the cellular telephones.

### CROSS REFERENCE TO RELATED APPLICATIONS

The present application claims benefit of and priority to U.S. Provisional Patent Application Ser. No. 61/053,983 entitled CELLULAR TELEPHONE filed May 16, 2008, the entire contents of which are hereby incorporated by reference herein.

### BACKGROUND

1. Field of the Disclosure

The present invention relates to a cellular telephone operable to transmit voice information along with other digital data for reception by other similarly functioning cellular telephone without the need for an external server.

2. Related Art

Cellular telephones, often simply referred to as cell phones, have become an almost necessary accessory in today's world. Increases in available bandwidth and improvements in cellular telephone technology have resulted in a new generation of “smart phones” which allow for greatly increased functionality. These smart phones typically allow for e-mail access, Internet access and often include sufficient memory to store and reproduce music or video as well.

Recently, video phone technology has been incorporated into video cellular telephones to allow video conferencing between cellular telephones. These cellular telephones typically include dedicated videophone modules that use established protocols to transmit and receive synchronized voice and video data with another videophone cell phone such that videoconferencing can take place in most any environment.

Unfortunately, the cost of these highly functional smart phones has risen steadily as their functionality has increased. Further, premium charges are typically charged for use of data networks, or servers. In order to include these advanced features, cellular telephones require more advanced hardware and software. To date, it has not been possible to provide such advanced features on a standard cellular telephone.

Accordingly, it would be advantageous to provide a cellular telephone that avoids the problems described above.

### SUMMARY

It is an object of the present invention to provide a cellular telephone that embeds digital data for transmission to another cellular telephone in conventional voice call information such that no content network or server is necessary.

A cellular telephone in accordance with an embodiment of the present application includes a transceiver operable to transmit and receive voice data and additional digital data and a controller operable to control the transceiver to transmit the voice data and other digital data. The controller is operable to provide data scheduling functions to ensure proper transmission of the digital data.

A method of providing communication from a cellular telephone including a transceiver for transmitting and receiving data and a controller for controlling the transceiver in accordance with an embodiment of the present application includes combining voice data and additional video data and transmitting the voice data and the additional video data to a recipient cellular telephone.

A cellular telephone in accordance with an embodiment of the present application includes a transceiver operable to transmit and receive voice data and additional digital data and a controller operable to control the transceiver to receive voice data and additional digital data, wherein the controller is operable to extract the received additional digital data from the voice data based on a received flag in the data for presentation to a user.

A cellular telephone in accordance with an embodiment of the present application includes an audio microphone operative to convert voice signals into electrical voice signals, an image capture device operative to convert image signals representative of at least one of a still image or a sequence of images, a display device operable to display the least one of a still image or a sequence of images, an analog to digital converter operative to convert the electrical voice signals into digital voice samples, an image coder operative to convert the image signals into encoded digital image signals, a voice coder for converting the digital voice samples into encoded digital voice signals, a transceiver that transmits the encoded digital voice and image signals over a digital voice channel of a wireless communications network and a controller operable to control the transceiver to transmit the digital voice and image data, wherein the controller is operable to provide data scheduling functions to ensure proper transmission of the additional digital data.

A cellular telephone in accordance with an embodiment of the present application includes a display device operable to display at least one of a still image or a sequence of images, an analog to digital converter operative to convert digital voice samples into electrical voice signals, an image decoder operative to convert encoded digital image signals into image signals for the display device, a voice decoder for converting encoded digital voice signals into electrical voice signals, a transceiver that receives encoded digital voice and image signals over a digital voice channel of a wireless communications network; and a controller operable to extract the encoded image signals from the encoded digital voice signals based on a received flag in the received data for presentation to a user.

Other features and advantages of the present invention will become apparent from the following description of the invention which refers to the accompanying drawings.

### BRIEF DESCRIPTION OF THE DRAWING(S)

FIG. 1 is a front perspective view of a cellular telephone in accordance with an embodiment of the present application.

FIG. 2 is an exemplary block diagram of the cellular telephone of FIG. 1.

FIG. 3 is a block diagram illustrating communication between the cellular telephone of FIG. 1 and other similarly functioning cellular telephones.

FIG. 4 is an exemplary flow chart illustrating operation of a cellular telephone in accordance with an embodiment of the present application.

### DETAILED DESCRIPTION OF EMBODIMENTS

As is noted above, cellular telephone communication has developed to the point where cellular phones are able to perform many of the functions previously only provided by computers and/or dedicated media players. However, the increased functionality typically requires more complex and expensive “smart phones.” The present application describes a simple cellular telephone that includes these features without the need for the expensive and complicated smart phone technology discussed above. In a preferred embodiment, the cellular telephone includes a camera as well, however, this is not necessary unless video conferencing or messaging is desired.

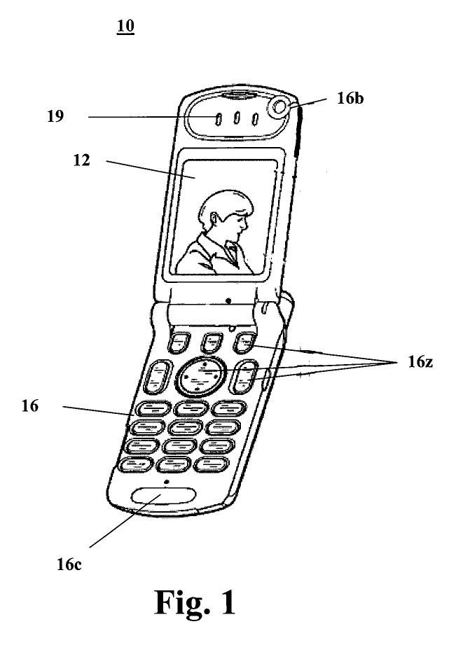

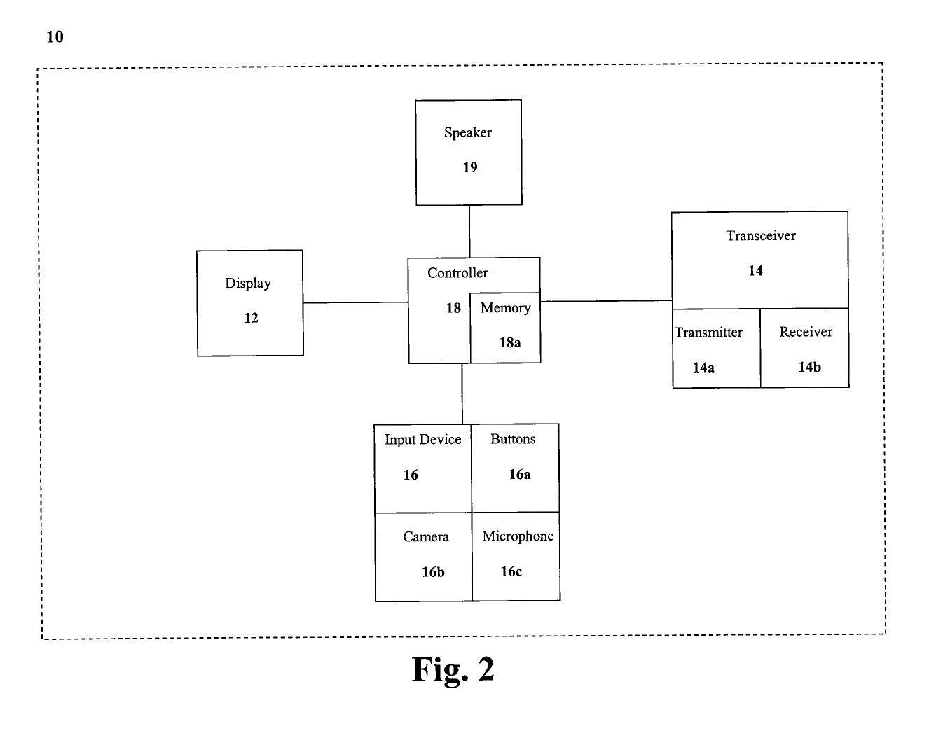

FIG. 1 illustrates an exemplary embodiment of a cellular telephone 10 in accordance with an embodiment of the present application. The cellular telephone 10 preferably includes a display 12, a transceiver 14 (see FIG. 2), an input device, or devices, 16 and a controller 18 (FIG. 2) that controls the display, transceiver and input device. In addition, a speaker 19 and microphone 16c may also be provided and controlled by controller 18.

The display 12 is preferably a color LCD display capable of displaying image data and text data to a user. The display size may vary, however, it should be suitable for use in a cellular telephone and at the same time sufficiently large to allow a user to view recorded media or messages clearly. While an LCD display is preferred, any suitable display device may be used.

As can be seen in FIG. 2, the transceiver 14 preferably includes a transmitter portion 14a that transmits signals out of the phone 10 and a receiver portion 14b for receiving signals transmitted to the phone 10. These signals are typically radio frequency signals commonly used in cellular telephone systems. An antenna (not shown) may be connected to the transceiver 14 to aid in transmitting and receiving data. The transceiver 14 may also include an encoder and/or decoder (not shown) used to encode and decode data that is transmitted from or received by the phone 10. Encoding and decoding techniques may vary depending on the modulation scheme used in transmitting and receiving data and the encoding and decoding provided in the cellular telephone 10 of the present application may use any suitable modulation scheme.

The input device 16 may include an alphanumeric keypad and additional buttons 16a used to enter information and/or indicate user preferences to the phone 10. In addition, a camera 16b and microphone 16c are preferably provided to allow image information and audio information, respectively, to be entered into the cellular telephone 10. The input device 16 preferably also includes one or more receptacles (not shown) to allow data to be transferred electronically via a cable, for example, into the cellular telephone 10, if desired.

The controller 18 may be a microprocessor, or any other device suitable to provide control signals to the components of the telephone 10 discussed above. In a preferred embodiment, the controller 18 will include a memory unit 18a. The memory unit 18a preferably stores program instructions, executable by the controller 18, for controlling the communication of data between cellular telephone 10 and other cellular telephones and may also hold the text, audio, video or other digital data that may be shared between cellular telephones. In an alternative embodiment, the memory unit 18a may be implemented as a separate component connected to the controller 18, if desired.

One advantage provided by the cellular telephone 10 of the present application is that it is embodied using conventional camera phone components and does not require the additional and costly components that are required by the “smart phones” discussed above to provide similar functionality.

In operation, the cellular telephone 10 allows a user to share virtually any type of digital data with any other similar cellular telephone via the call information, typically voice information, that is conventionally transmitted between cellular telephones during a voice phone call. Both cellular telephones operate in a similar manner based on a set of instructions provided preferably via software loaded onto the phones. That is, in the cellular telephone(s) the digital data is embedded in the call information and transmitted in the same manner as an ordinary voice call would be transmitted. In this manner, a user can send text messages, voice messages, video and voice messages, or images to another user without the need to use a separate data network, or server. At the receiving end, a similar controller of the receiving cellular telephone extracts the digital data from the voice call information. The extracted data may be stored in the memory unit of the receiving phones, or displayed directly to the user.

In a preferred embodiment, the user of the receiving cellular phone need not answer the incoming call in order to receive the embedded digital data. That is, the receiving cellular phone preferably automatically extracts the data from the call information whether or not the user answers the call. In a preferred embodiment, the controller 18 causes the cellular telephone 10 to insert a flag in the sent voice information, which indicates that there is data embedded in the call information. This flag is recognized by the receiving telephone, which preferably extracts the digital data, whether or not the user manually answers the phone.

Similarly, the controller 18 of the cellular telephone 10 recognizes a flag in an incoming call that indicates that data is embedded in the call information. The controller 18 then controls the receiver 14a to accept the call and to extract any data embedded in the incoming call information. The user need not manually answer the incoming call unless desired. That is, the controller 18 may automatically answer the incoming call and extract the embedded information. Further, since the data can be quickly extracted from the incoming call information, call time is minimized such that usage charges by the cellular network provider are also minimized. The embedded digital data may be extracted and saved in the memory 18a for future use by the user. A reminder, or other indicator, of a received message may be displayed visually or otherwise conveyed to the user of the cellular telephone 10 to indicate that a message is waiting. In addition, after a user has viewed a message, a confirmation signal may be provided by the controller 18 and sent to the sending telephone to notify the sender that the message has been viewed.

Alternatively, the telephone 10 may simply save the message and attempt to send it at a later time. For example, if the recipient phone is unreachable, or otherwise unavailable, the telephone 10 may save the message and attempt to send it at a later time. The telephone 10 will preferably keep trying to send the message until the recipient phone is contacted and confirm receipt. Alternatively, the telephone 10 may forward the message to a non-recipient phone, which will then send the message to the recipient phone at an appropriate time.

Further, the controller 18 is preferably operable to conduct a video conference call in which real time video is transmitted (or received) along with synchronized real time audio voice information to (or from) another cellular telephone. In a preferred embodiment, the controller 18 may insert a second flag into the call information to the receiving cellular telephone. This second flag indicates that a videoconference is requested. Similarly, the controller 18 is able to recognize such a second flag in any received call information. After receiving such a flag, the controller 18 preferably displays a notice to the user, preferably on the display 12, however, an audio signal conveyed via speaker 19 may be used. The user will then have the option of accepting the request. Typically, the user will press a selected button of the input device 16 to accept the request for a videoconference, however, any button may be used. In this case, the controller 18 will not accept the call automatically since a videoconference will typically require real time interaction on the part of both users.

In a preferred embodiment, the real time video data is obtained using the camera 16b and embedded in the call information for transmission to the user. No dedicated video conferencing module is required and there is no requirement for the use of a separate data network or server. The microphone 16c picks up the voice information as it would with a conventional cellular telephone call.

In another embodiment, the cellular telephone 10 may be used to allow users to play video games remotely. In this embodiment, images and game data are embedded in the call, or voice, information in much the same way that voice data and video are embedded in the videoconferencing embodiment described above. In addition, game control instructions are also embedded into the voice data such that they are received by the receiving cellular telephone.

In general, the cellular telephone 10 of the present application allows for direct cellular telephone to cellular telephone transmission of virtually any type of digital data, along with voice data. The additional data may be voice mail, video messages, text messages, video conference information (real time audio and video information), video game information, pictures or any other digital data, for example documents or spreadsheets which may be PDF files, word processor files or spreadsheet files. Further, in the context of a videoconference, the cellular telephone 10 is preferably also able to communicate with more than one phone at a time as well.

In all embodiments, the controller 18 preferably controls the transceiver 14 to embed digital data along with the call information that would ordinarily be used in establishing and maintaining a cellular telephone call. Thus, the data is transmitted as if it were a part of a regular voice call. On the receiving end, the data is separated out from the voice information either at the transceiver or by the controller of the recipient cellular telephone. The embedding or extracting of the digital data may be a part of the coding and decoding discussed above, or may be performed by the controller 18 if desired. In either case, the controller 18 controls the embedding and extraction of the data in accordance with program instructions stored in the memory 18a. In this manner, a simple cellular telephone with a camera can be used to provide much of the advanced functionality that is provided by the more complex and expensive smart phones discussed above.

In a preferred embodiment, the telephone 10 operates as a server in order to coordinate communication of data directly with another cellular telephone or telephones. Thus, there is no need for an external server. This may include storing messages and scheduling later delivery of the message and/or choosing a particular path for a message to be sent to another telephone to maximize efficiency or limit power consumption, for example.

Thus, the cellular telephone 10 of the present application provides increased functionality using a simplified hardware structure. The cellular telephone 10 embeds additional digital data into the voice call information such that text, audio and video data can be transmitted in conventional call information and received and extracted by a similar receiving phone without the need for a data network or external server.

In a preferred embodiment, the cellular telephone 10 communicates with other similar telephones. That is, the telephone 10 communicates with other cellular telephones that include similar functionality. In one embodiment, the controller 18b stores a list of identification information for other similar telephones. For example, the telephone numbers of such other telephones. Each other these other telephones are similarly operative to both transmit and receive digital data in the manner described above. In addition, each of these other cellular telephone may operate as a server to store and or otherwise direct data, either for itself or for other cellular telephones. Thus, there is no need to use an external server. This feature is particularly useful in a situation where an intended recipient is unavailable or unreachable for some reason since other similarly function cellular telephones can simply store the message for later transmission.

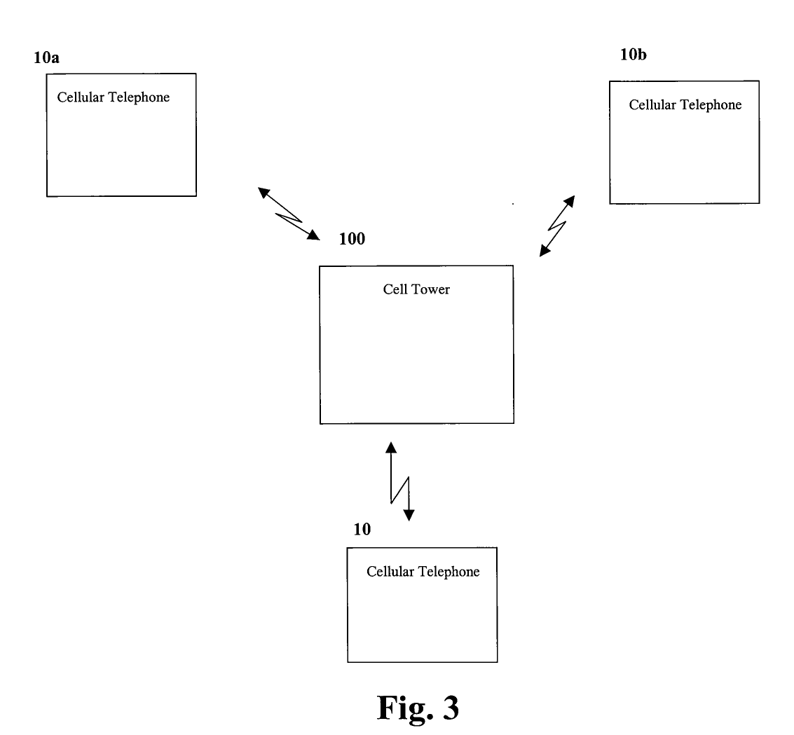

For example, in the block diagram of FIG. 3, two cellular telephones 10 and 10a are illustrated communicating in a cellular network via a cell tower 100. Both of these cellular telephones is capable of sending and receiving digital data in the manner described above. If cellular telephone 10 attempts to transmit digital data to cellular telephone 10a and the telephone 10a is, for some reason, unable to receive the message, the telephone 10 may store the message for later transmission if desired, as mentioned above. Alternatively, the digital data may be transmitted to a third, similarly functional cellular telephone, for example cell phone 10b. In this case, the telephone 10b may store the digital data on behalf of the telephone 10 for later transmission to the telephone 10a, when it becomes available. Thus, the telephone 10b operates as a server to direct data between the telephone 10 and the telephone 10b. While the telephone utilizes the tower 100 of the cellular telephone, there is no need to use any external servers in that system.

In another embodiment, where the data to be transmitted is sensitive or confidential, and the receiving telephone is unavailable, the data may be divided into different packages and forwarded to a plurality of similarly functioning cellular telephones that are available, including, for example, cellular telephone 10b in FIG. 3. These other telephones can then forward the data to the intended recipient when it becomes available. Since no one telephone has all of the data, the confidentiality of the data is maintained, while ensuring that the intended recipient still receives the data. In a preferred embodiment, the data is cryptographically divided, or shredded, to ensure that the data stored on any of the non-intended recipient phones cannot be used to determine the content of the sensitive data. For example, presuming a 128 bit message, selected bits may be separated and sent to each of the plurality of phones.

One example of when a particular cellular telephone might be unavailable is when it is outside the range of any cell tower. Despite the very developed cellular telephone infrastructure in this country, it is not uncommon, for any particular cellular telephone to temporarily lose contact with a cell tower. At this time, communication to and from this phone is unavailable. In addition, since cellular telephones are routinely used while the user is in motion, it is not at all uncommon for a particular user to move in and out of range of a cell tower.

The controller 18 will generally monitor the telephone's 10 connection status with the cellular network, for example, with the cell tower 100. This is typically done by monitoring signal strength of transmissions from the cell tower 100, for example. This is routinely done in order to ensure that communication is possible. In a preferred embodiment, the controller 18 will generate a connection log of this connection status. Based on the connection information in the log, the controller 18 will be able to determine the times of day, for example, when cellular telephone 10 is generally within range of cellular tower 100. Based on such information, the controller 18 will be better able to schedule transmission of the digital data, either on its own behalf or on the behalf of other similar cellular telephones, such as telephone 10a, 10b. While scheduling of transmissions is not as critical when a live video conference is desired, since such transmissions must be done in real time, and thus, cannot be postponed, the log information may be used to provide a suggestion for a particular time when such a conference would likely be optimum. For example, the controller 18 could generate a list of suggested times for conferences based on the connection log information. In this case, the controller 18 would preferably select times of optimum signal strength, rather than just simply connectivity. That is, it would be desirable to ensure that not only is telephone 10 connected to the network, but that it has an optimum signal strength as well.

In addition, the controller 18 preferably also includes position tracking capabilities. That is, the controller 18 is preferably ale to determine the position of the telephone 10. Preferably this location is stored in combination with the signal strength information discussed above such that a record of locations and associated signal strengths can be maintained by the controller 18. The controller 18 preferably uses this information in order to schedule transmission of the digital data. Further, this information may also be used to suggest videoconference times and locations as well. Further, this information may be used to determine the location of cell towers as well. The location information of the telephone 10 may also be used to determine the location of the cell tower 100. The controller 18 may also take cell tower location into account to schedule transmission.

Power management is another consideration for the cellular telephone 10. Since the telephone 10 is generally similar to conventional, non-smart phone type telephones, it preferably uses a conventional battery. Of course, enhanced life batteries are also available. Nonetheless, optimizing battery life is preferred. Thus, the controller 18 preferably also monitors power usage as well. In a preferred embodiment, this power usage information is also logged along with the location and signal strength information. Generally, the cellular telephone 10 will use less power when it is closer to a cell tower. Thus, the controller 18 will preferably select transmission times, when possible, when minimum power will be necessary to transmit. Further, the power use information can be used to confirm that transmissions occur under conditions where power usage is minimized even if, for example, this corresponds to a time or location where the phone 10 is relatively distant from a cell tower 100, for example. In this manner, the cellular telephone 10 maximizes battery life.

In a preferred embodiment, the controller 18 of cellular telephone 10 is further operable to provide a set of executable instructions to another cellular telephone. That is, the controller 18 may transmit software to another cellular telephone. In this case, the other cellular telephone need not have the same capabilities as the cellular telephone 10. Indeed, the set of executable instructions that are provided to the other cellular telephone are instructions that will allow the other telephone to operate in a similar manner as the cellular telephone 10. Thus, the user of cellular telephone 10 may spread the software to their friends or associates and add them to the list of compatible telephones mentioned above. In one embodiment, these other users may be charged a fee for using the software, for example, upon installation of the program on their telephone, for example. In this case, the software may include instruction to register the phone and charge the fee. The fee may be collected by the cellular service provider, for example, or otherwise billed to a user. Alternatively, the software may be transferred without a fee, if desired. In another embodiment, the user of the cellular telephone 10 may be able to forward a predetermined number of copies without a fee, and thereafter, a fee is charged.

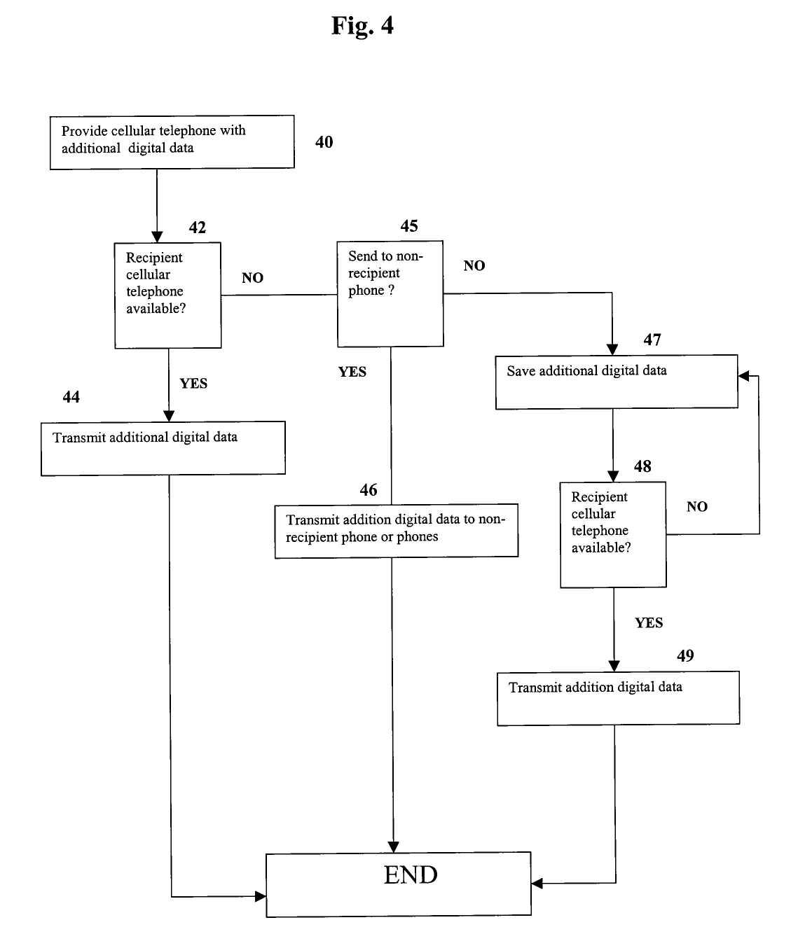

FIG. 4 illustrates an exemplary flow chart demonstrating operation of the cellular telephone of the present application. At step 40 additional digital data is provided for transmission. As is noted above, the additional digital data may take many forms including images, videos, e-mails text messages, documents, etc. At step 42, a determination is made as to whether an intended recipient of the information is available. If so, (YES at step 42) additional digital data is sent to the recipient in step 44. As is noted above, if the recipient cellular telephone is not available (NO at step 42) the additional digital data may be stored and transmitted at a future time or may be sent to a non-recipient telephone to be or forwarded to the recipient when it becomes available. The user may be given the choice of whether the data should be sent to a non-recipient or the decision made automatically. At step 45, a determination is made as to whether the data is to be sent to a non-recipient cellular telephone. If so, (YES at step 45) then the additional data is sent to a compatible non-recipient telephone at step 46. If the data is not to be sent to a non-recipient (NO at step 45) then the additional digital data is stored as step 47. After a period of time the availability of the recipient is determined again at step 48. If available, the data is transmitted at step 49. If not, the method returns to step 47 and repeats. After transmission, the method may end, however, this is not necessary as the process may be repeated for additional digital data. While FIG. 4 illustrates an exemplary flow chart for the cellular telephone of the present application, many variations are possible as described herein.

Although the present invention has been described in relation to particular embodiments thereof, many other variations and modifications and other uses will become apparent to those skilled in the art.

What is claimed is:

1. A cellular telephone comprising:
a transceiver operable to transmit and receive voice data and additional digital data; and
a controller operable to control the transceiver to transmit the voice data and other digital data, wherein the controller is operable to provide data scheduling functions to ensure proper transmission of the additional digital data.

2. The cellular telephone of claim 1, wherein the voice data and additional digital data are transmitted together when a recipient cellular telephone is available for communication.

3. The cellular telephone of claim 2, wherein the additional digital data includes a flag to indicate to the recipient cellular telephone that the additional digital data is being sent thereto.

4. The cellular telephone of claim 1, wherein the controller is further operable to receive voice data and received additional digital data, to extract the received additional digital data from the voice data based on a received flag in the data for presentation to a user.

5. The cellular telephone of claim 4, wherein the controller provides a confirmation signal to be sent a sending cellular telephone when a user views the received additional data.

6. The cellular telephone of claim 5, wherein the data scheduling function provided by the controller includes storing the additional digital data in the cellular telephone when a recipient cellular telephone is unavailable, and then transmitting the additional digital data at a future time.

7. The cellular telephone of claim 6, wherein the future time is a predetermined period of time following a first attempt to send the additional digital data, the cellular telephone operable to continue to attempt to transmit the additional digital data until the additional digital data is received by the recipient cellular telephone.

8. The cellular telephone of claim 7, wherein the controller is operable to monitor a connection status between the cellular telephone and a cellular tower of a cellular communication system and to record connection status information over a period of time to provide a connection log.

9. The cellular telephone of claim 8, wherein the future time of transmission is selected based on the connection status information such that the future time is a time when the cellular telephone is likely to be connected to the cellular tower.

10. The cellular telephone of claim 9, wherein the controller further comprises location circuitry operable to determine a location of the cellular telephone, record location over time and to associate the location information with the connection status information.

11. The cellular telephone of claim 10, wherein the future time is selected by the controller such that it is at a time when the cellular telephone is likely to be in a location in which it is likely to be connected to the cellular tower.

12. The cellular telephone of claim 11, wherein a location of the cellular tower is determined based on the connection status information and location information, and wherein the future time is selected by the controller to be a time when the cellular telephone is likely to be near the cell tower.

13. The cellular telephone of claim 12, further comprising a memory device connected to the controller, the memory device operable to store the connection status information, location information and cellular tower location information.

14. The cellular telephone of claim 5, wherein the data scheduling function provided by the controller includes controlling the transceiver to forward additional digital data to a non-recipient cellular telephone when the recipient cellular telephone is unavailable.

15. The cellular telephone of claim 14, wherein the memory device is further operable to store a list of compatible cellular telephones, and wherein the non-recipient telephone is selected from the list of compatible cellular telephones.

16. The cellular telephone of claim 15, wherein the controller separates the additional digital data into a plurality of sections and transmits each section to a separate non-recipient telephone selected from the list of compatible cellular telephones, wherein the separation of the data is performed such that data in each of the plurality of sections appears to be random and includes a subset of all additional digital data.

17. The cellular telephone of claim 16, wherein the controller receives a plurality of received sections of digital data from a plurality of compatible cellular telephones and combines the received sections of digital data to return the additional digital data to its original format.

18. The cellular telephone of claim 1, wherein the controller is further operable to receive received additional digital data from another compatible cellular telephone.

19. The cellular telephone of claim 1, wherein the additional digital data transmitted from the cellular telephone is the received additional digital data, and wherein the received additional digital data includes information related to an intended recipient cellular telephone for the received additional digital data.

20. The cellular telephone of claim 1, wherein the controller controls transmission of the additional digital data such that power consumption is minimized.

21. The cellular telephone of claim 1, wherein the additional digital data includes a set of executable instructions defining the operation of the controller, and wherein the additional digital data is transmitted to a non-compatible cellular telephone such that the non-compatible digital telephone implements the executable instructions to become a compatible cellular telephone.

22. A method of providing communication from a cellular telephone including a transceiver for transmitting and receiving data and a controller for controlling the transceiver, the method comprising;
combining voice data and additional video data; and
transmitting the voice data and the additional video data to a recipient cellular telephone, wherein the controller coordinates transmission of the additional digital data.

23. The method of claim 22, wherein the voice data and additional digital data are transmitted together when the recipient cellular telephone is available for communication.

24. The method of claim 23, wherein the additional digital data includes a flag to indicate to the recipient cellular telephone that the additional digital data is being sent thereto.

25. The method of claim 24, further comprising:
receiving voice data and received additional digital data; and
extracting the received additional digital data from the voice data based on a received flag in the data for presentation to a user.

26. The method of claim 25, further comprising
providing a confirmation signal when a user has viewed the extracted additional digital data; and
sending the confirmation signal to a sender cellular telephone.

27. The method of claim 26, further comprising:
storing, in the cellular telephone, the additional digital data when the recipient cellular telephone is unavailable, and
transmitting the additional digital data at a future time.

28. The method of claim 27, wherein the future time is a predetermined period of time a following a first attempt to send the transmit the additional digital data, and
repeating the transmitting step until the additional digital data is received by the recipient cellular telephone

29. The method of claim 28, further comprising:
monitoring a connection status between the cellular telephone and a cellular tower of a cellular communication system; and
recording connection status information over a period of time to provide a connection log.

30. The method of claim 29, further comprising:
selecting the future time of transmission based on the connection status information such that the future time is a time when the cellular telephone is likely to be connected to the cellular tower.

31. The method of claim 30, further comprising:
determining a location of the cellular telephone; and
recording location over time along with the connection status information, wherein the future time of transmission is selected such that it is at a time when the cellular telephone is in a location in which it is likely to be connected to the cellular tower.

32. The method of claim 31, further comprising:
determining a location of the cellular tower based on the connection status information and location information, wherein the future time of transmission is selected such that it is a time when the cellular telephone is likely to be near the cellular tower.

33. The method of claim 32, further comprising:
storing the connection status information, location information and cellular tower location information in a memory device.

34. The method of claim 26, further comprising:
transmitting the additional digital information to a non-recipient cellular telephone when the recipient cellular telephone is unavailable.

35. The method of claim 34, further comprising:
selecting at least one non-recipient cellular telephone from a list of compatible cellular telephones.

36. The method of claim 35, further comprising:
dividing the additional digital data into plural sections; and
transmitting the plural sections to a plurality of non-recipient cellular telephones from the list.

37. The method of claim 22, further comprising:
receiving a plurality of received sections of digital data from a plurality of compatible cellular telephones; and
combining the received sections of digital data to return the additional digital data to its original format.

38. The method of claim 37, wherein the additional digital data is received additional digital data received from a particular compatible cellular telephone, and wherein the received additional digital data includes information related to the intended recipient cellular telephone associated therewith such that transmission of the digital data is to the intended recipient cellular telephone.

39. The method of claim 22, wherein the additional digital data includes a set of executable instructions defining the operation of the controller, and wherein the additional digital data is transmitted to a non-compatible cellular telephone such that the non-compatible digital telephone implements the instructions to become a compatible cellular telephone.

40. A cellular telephone comprising:
a transceiver operable to transmit and receive voice data and additional digital data; and
a controller operable to control the transceiver to receive voice data and additional digital data, wherein the controller is operable to extract the received additional digital data from the voice data based on a received flag in the data for presentation to a user.

41. The cellular telephone of claim 40, wherein the controller provides a confirmation signal to be sent to a sending cellular telephone when the user views the received additional data.

42. A cellular telephone, comprising:
an audio microphone operative to convert voice signals into electrical voice signals;
an image capture device operative to convert image signals representative of at least one of a still image or a sequence of images;
a display device operable to display the least one of a still image or a sequence of images;
an analog to digital converter operative to convert the electrical voice signals into digital voice samples;
an image coder operative to convert the image signals into encoded digital image signals;
a voice coder for converting the digital voice samples into encoded digital voice signals;
a transceiver that transmits the encoded digital voice and image signals over a digital voice channel of a wireless communications network; and
a controller operable to control the transceiver to transmit the digital voice and image data, wherein the controller is operable to provide data scheduling functions to ensure proper transmission of the additional digital data.

43. A cellular telephone, comprising:
a display device operable to display at least one of a still image or a sequence of images;
an analog to digital converter operative to convert digital voice samples into electrical voice signals;
an image decoder operative to convert encoded digital image signals into image signals for the display device;
a voice decoder for converting encoded digital voice signals into electrical voice signals;
a transceiver that receives encoded digital voice and image signals over a digital voice channel of a wireless communications network; and
a controller operable to extract the encoded image signals from the encoded digital voice signals based on a received flag in the received data for presentation to a user.
